(19) United States
(12) Patent Application Publication
(10) Pub. No.: US 2014/0313110 A1
(43) Pub. Date: Oct. 23, 2014

(54) DISPLAY DEVICE

(71) Applicant: Japan Display, Inc., Tokyo (JP)

(72) Inventors: Masato ITO, Tokyo (JP); Toshihiro SATO, Tokyo (JP); Tomoki NAKAMURA, Tokyo (JP)

(73) Assignee: Japan Display, Inc., Tokyo (JP)

(21) Appl. No.: 14/256,149

(22) Filed: Apr. 18, 2014

(30) Foreign Application Priority Data
Apr. 19, 2013 (JP) 2013-088828

(51) Int. Cl. G09G 3/32

(52) U.S. Cl. CPC G09G 3/3208
USPC 345/77

(57) ABSTRACT

A display device includes plural pixel circuits; a red color filter that transmits a red light, a blue color filter that transmits a blue light, and a green color filter that transmits a green light. Each of the plural pixel circuits includes a light emission area that outputs a white light of brightness corresponding to an input image signal. The light emission area of the pixel circuit that receives the image signal indicative of the brightness of white among the plural pixel circuits is covered with the red color filter, the blue color filter, and the green color filter.

### CROSS-REFERENCE TO RELATED APPLICATION

The present application claims priority from Japanese application JP2013-088828 filed on Apr. 19, 2013, the content of which is hereby incorporated by reference into this application.

### BACKGROUND OF THE INVENTION

1. Field of the Invention

The present invention relates to a display device, and more particularly to a display device having pixels formed of spontaneous light emitting elements such as organic EL elements.

2. Description of the Related Art

There are display devices using the spontaneous light emitting elements such as the organic EL elements. Also, in order to represent various colors, there are the following two realization systems. In one system, three kinds of light emitting elements that emit the respective lights of red, blue, and green are formed on a substrate. In the other system, light emitting elements that emit a light of white are formed on a substrate, and the light emitting elements are covered with color filters.

In particular, in the latter system, it is conceivable to express one pixel by adding a sub-pixel of white to sub-pixels of red, blue, and green for the purpose of reducing the power consumption. Each of the sub-pixels is realized by a pixel circuit including the spontaneous light emitting element, and a color filter that transmits a part of spectrums of light output by the light emitting element.

JP 2004-311440 A discloses a display device including sub-pixels that display red, blue, green, and white with the use of color filters.

### SUMMARY OF THE INVENTION

When pixels of red, blue, green, and white are configured by white light emitting element, and the color filters, it is conceivable that a light emitting portion of the pixel circuit corresponding to white is not covered with the color filter. However, the light output by the spontaneous light emitting element of white looks white when viewed from a front surface, but looks green when viewed from a side. Thus, color tone is changed.

The present invention has been made in view of the above problem, and an object of the invention is to provide a display device that suppresses a deviation of a light tone of a light which is output from the pixel circuit for expressing the grayscale of white and reaches an observer from the white.

A typical outline of the invention disclosed in the present application will be described in brief below.
(1) A display device including: a plurality of pixel circuits; a red color filter that transmits a red light; a blue color filter that transmits a blue light; and a green color filter that transmits a green light, in which each of the plurality of pixel circuits includes a light emission area that outputs a white light of brightness corresponding to an input image signal, and a part or entirety of the light emission area of the pixel circuit that receives the image signal indicative of the brightness of white among the plurality of pixel circuits is covered with the red color filter, the blue color filter, and the green color filter.
(2) The display device according to the item (1), in which a light emission area of the pixel circuit that receives an image signal indicative of the brightness of red among the plurality of pixel circuits is covered with the red color filter, a light emission area of the pixel circuit that receives an image signal indicative of the brightness of blue among the plurality of pixel circuits is covered with the blue color filter, a light emission area of the pixel circuit that receives an image signal indicative of the brightness of green among the plurality of pixel circuits is covered with the green color filter, and the pixel circuit that receives the image signal indicative of the brightness of red, the pixel circuit that receives the image signal indicative of the brightness of blue, the pixel circuit that receives the image signal indicative of the brightness of green, and the pixel circuit that receives the image signal indicative of the brightness of white express one pixel.
(3) The display device according to the item (2), in which the transmittances of the red color filter, the blue color filter, and the green color filter which cover the light emission area of the pixel circuit that receives the image signal indicative of the brightness of white are larger than the transmittances of the red color filter, the blue color filter, and the green color filter which cover the light emission areas of the pixel circuits that receive the image signals indicative of the brightness of red, blue, and green, respectively.

According to the present invention, in the display device using the spontaneous light emitting elements, a deviation of a light tone of a light which is output from the pixel circuit for expressing the gray level of white and reaches an observer from the white can be suppressed.

### BRIEF DESCRIPTION OF THE DRAWINGS

FIG. 1 is a diagram illustrating an example of an equivalent circuit of an organic EL display device according to an embodiment of the present invention;

FIG. 2 is a diagram illustrating one example of a layout of light emission areas and color filters in a certain pixel;

FIG. 3 is a diagram illustrating a comparative example of a layout of sub-pixels in each pixel of an organic EL display device;

FIG. 4 is a diagram illustrating another example of a layout of the light emission areas and the color filters in a certain pixel;

FIG. 5 is a diagram illustrating still another example of a layout of the light emission areas and the color filters in a certain pixel;

FIG. 6 is a diagram illustrating yet still another example of a layout of the light emission areas and the color filters in a certain pixel; and

FIG. 7 is a diagram illustrating yet still another example of a layout of the light emission areas and the color filters in a certain pixel.

### DETAILED DESCRIPTION OF THE INVENTION

Hereinafter, embodiments of the present invention will be described with reference to the accompanying drawings. Components having the same function are indicated by identical reference characters, and its description will be omitted. In this example, an example of an organic EL display device will be described as a display device using the spontaneous light emitting elements.

The organic EL display device physically includes an array substrate having a plurality of pixel circuits PCR, PCG, PCB, and PCW, a color filter substrate facing the array substrate, and a flexible substrate connected to the array substrate.

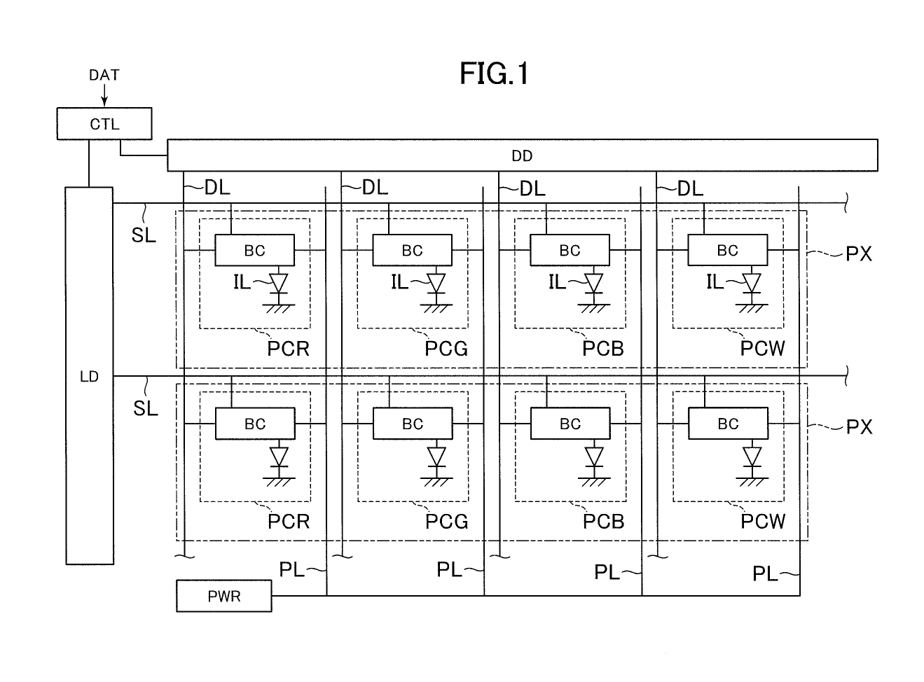

FIG. 1 is a diagram illustrating an example of an equivalent circuit of an organic EL display device according to an embodiment of the present invention. The layout of the circuit illustrated in FIG. 1 does not match a physical layout at all.

The organic EL display device includes a control unit CTL, an image signal line driver circuit DD, a scanning line driver circuit LD, a plurality of pixel circuits PCR, PCG, PCB, and PCW, a plurality of image signal lines DL, a plurality of scanning lines SL, and a power unit PWR.

A display area of the organic EL display device is configured by pixels PX arrayed in a matrix, and each of those pixels PX is configured by sub-pixels of red, blue, green, and white. The pixel circuits PCR of red each materializes a sub-pixel of red, the pixel circuits PCG of green each materializes a sub-pixel of green, the pixel circuits PCB of blue each materializes a sub-pixel of blue, and the pixel circuits PCW of white each materializes a sub-pixel of white. Although only two pixels PX are illustrated in FIG. 1, the pixels PX corresponding to the resolution are actually aligned.

The control unit CTL acquires image data DAT, obtains gray levels of the respective brightness of the sub-pixels of red, blue, green, and white configuring the respective pixels PX on the basis of the image data DAT, and outputs gray level data of the gray levels toward the image signal line driver circuit DD. Also, the control unit CTL outputs a clock signal for controlling a timing at which the image signal line driver circuit DD outputs the image signal, a timing at which the scanning line driver circuit LD outputs a signal for controlling the pixel circuits PCR, PCG, PCB, and PCW and the like.

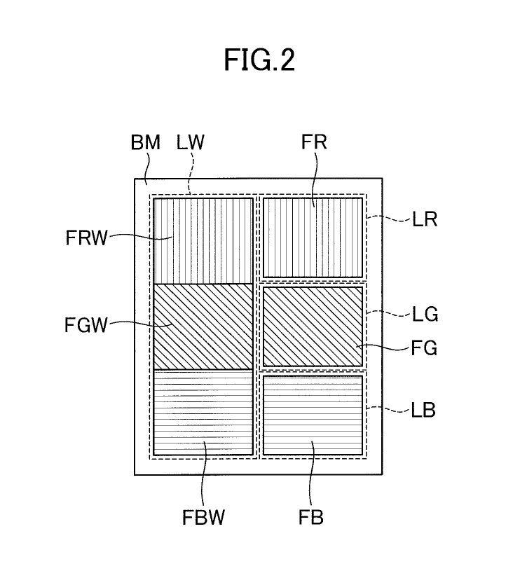

The image signal line driver circuit DD outputs the image signals indicative of the gray levels of the respective brightness of the sub-pixels of red, blue, green, and white to the image signal lines DL connected to the pixel circuits PCR, PCG, PCB, and PCW corresponding to the sub-pixels. The image signal lines DL are aligned in a horizontal direction of FIG. 2, and the image signal lines DL each extend a vertical direction. The scanning line driver circuit LD outputs scanning signals for controlling the operation of allowing the respective pixel circuits PCR, PCG, PCB, and PCW to store the gray levels indicated by the image signals, and the operation of emitting the light in that gray levels. The scanning signals are output to the scanning lines SL connected to those pixel circuits PCR, PCG, PCB, and PCW. The scanning lines SL are aligned in the vertical direction of FIG. 2, and extend in the horizontal direction. The respective scanning lines SL correspond to groups corresponding to the rows of the pixel circuits PCR, PCG, PCB, and PCW. Also, in FIG. 1 only one scanning line SL is illustrated in one group of the pixel circuits PCR, PCG, PCB, and PCW, but actually three or more scanning lines SL are present in one group. The three or more scanning lines SL control the timing at which the image signals are stored, the timing at which the light is emitted and the like.

The pixel circuits PCR, PCG, PCB, and PCW are formed on the array substrate. Each of the pixel circuits PCR, PCG, PCB, and PCW includes a light emitting element IL, and a brightness control circuit BC. In this example, the light emitting element IL is an organic EL element that outputs the light of white. A cathode of the light emitting element IL is connected to a ground electrode, and an anode thereof is connected to a brightness control circuit BC. The brightness control circuit BC controls the time and the amount of current flowing in the light emitting elements IL on the basis of the image signals and the signals from the scanning lines SL, and controls the light emission amount of the light emitting elements IL. The brightness control circuit BC is connected to the image signal line DL and the scanning line SL which correspond to the pixel circuits PCR, PCG, PCB, and PCW including the brightness control circuit BC. The brightness control circuit BC is connected to the power unit PWR via a power line PL. With those components, the light emitting elements IL output the white light of the brightness corresponding to the gray levels of the sub-pixels indicated by the input image signal.

FIG. 2 is a diagram illustrating one example of a layout of light emission areas LW, LR, LG, LB, and color filters in a certain pixel PX. In the area of one pixel PX, a light emission area LW of the light emitting element IL included in the white pixel circuit PCW, a light emission area LR of the light emitting element IL included in the red pixel circuit PCR, a light emission area LG of the light emitting element IL included in the green pixel circuit PCG, and a light emission area LB of the light emitting element IL included in the blue pixel circuit PCB are arranged. In the example of FIG. 2, the light emission area LW is a left half of the area of the pixel PX. In the right half of the area of the pixel PX, the light emission area LR, the light emission area LG, and the light emission area LB are arranged in order from the top. The sizes of the light emission area LR, the light emission area LG, and the light emission area LB are identical with each other, and the size of the light emission area LW is substantially identical with a total of the light emission area LR, the light emission area LG, and the light emission area LB.

Also, a part of those light emission areas LW, LR, LG, and LB is covered with the color filters and the like disposed on the color filter substrate. The color filters of red, green, and blue, and the black matrix BM are formed on the color filter substrate. Hereinafter, portions that do not overlap with the black matrix BM in the area where the color filters of red, green, and blue are formed are indicated by a red color filter FR, FRW, a green color filter FG, FGW, and a blue color filter FB, FBW. The red color filter FR, FRW, the green color filter FG, FGW, and the blue color filter FB, FBW do not overlap with each other in the plan view, and the black matrix BM is formed between the respective color filters except for portions to be described later.

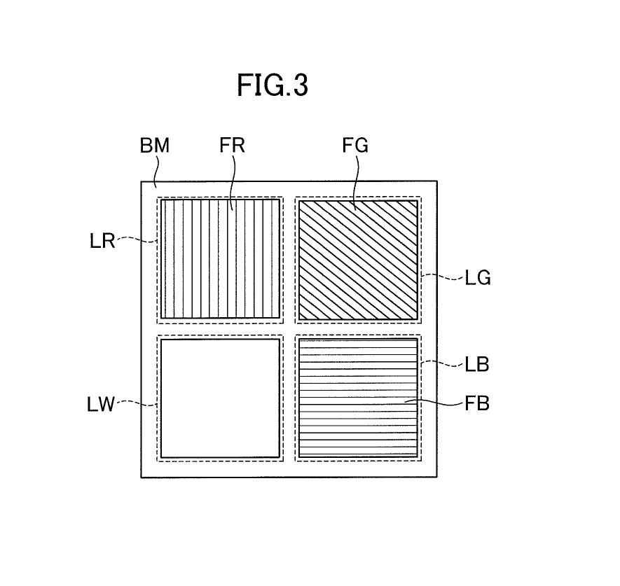

A positional relationship between the color filter, and the light emission areas LW, LR, LG, LB will be described below. The light emission area LR is covered with a red color filter FR. The light emission area LG is covered with a green color filter FG. The light emission area LB is covered with a blue color filter FB. On the other hand, the light emission area LW is covered with a red color filter FRW, a green color filter FGW, and a blue color filter FBW in order from the top in FIG. 2. In the plan view, the size of an area in which the light emission area LW and the red color filter FRW overlap with each other, the size of an area in which the light emission area LW and the green color filter FGW overlap with each other, and the size of an area in which the light emission area LW and the blue color filter FBW overlap with each other are identical with each other. The black matrix BM is not disposed between the red color filter FRW and the green color filter FGW, and between the green color filter FGW and the blue color filter FBW. In FIG. 2, a part of the light emission areas LW, LR, LG, and LB is covered with any one of the red color filter FR, FRW, the green color filter FG, FGW, and the blue color filter FB, FBW, but the overall light emission areas LW, LR, LG, and LB may be covered with any one of the red color filter FR, FRW, the green color filter FG, FGW, and the blue color filter FB, FBW. Also, in FIGS. 3 to 7 described below, the overall light emission areas LW, LR, LG, and LB may be covered with any one of the red color filter FR, FRW, the green color filter FG, FGW, and the blue color filter FB, FBW.

In the example of FIG. 2, the red color filter FR and the red color filter FRW are identical in transmittance with each other. The green color filter FG and the green color filter FGW are identical in transmittance with each other. The blue color filter FB and the blue color filter FBW are identical in transmittance with each other. The sizes of the light emission areas LW, LR, LG, LB, and the ratio of the red color filter FRW, the green color filter FGW, and the blue color filter FBW may be changed according to the characteristics of the color filters.

The white light emitted by the light emission area LW corresponding to the sub-pixel of white is converted into a red light transmitted through the red color filter FRW, a green light transmitted through the green color filter FGW, and a blue light transmitted through the blue color filter FBW. The set of the red light, the green light and the blue light looks white by the observer.

In this way, the light of the light emission area LW of the white sub-pixel is transmitted through the red color filter FRW, the green color filter FGW, and the blue color filter FBW, thereby being capable of preventing the spectrum of light from being deviated, and suppressing a change in the color tone in a direction viewed by the observer.

FIG. 3 is a diagram illustrating a comparative example of the layout of the sub-pixels in the organic EL display device. In the display device illustrated in FIG. 3, the light emission areas LW, LR, LG, and LB are arranged in a rectangular area of one pixel PX, but the light emission area LW is not covered with the color filters. In this case, not only the light of spectrum emitted by the light emitting elements IL reaches eyes of the observer as it is, but also the spectrum of the light is changed depending on the viewing direction of the observer due to an influence of an internal optical path length. For that reason, the color tone of the white sub-pixels is changed. In order to suppress the deviation of the color tone, it is conceivable to provide a polarization plate. However, this causes such a problem that the brightness of not only the white sub-pixel but also the red sub-pixel is lowered so that the power consumption cannot be reduced. On the other hand, in this embodiment, a change in the spectrum of light can be suppressed with the use of the color filters, and a change in the color tone can be suppressed without reducing the overall light amount.

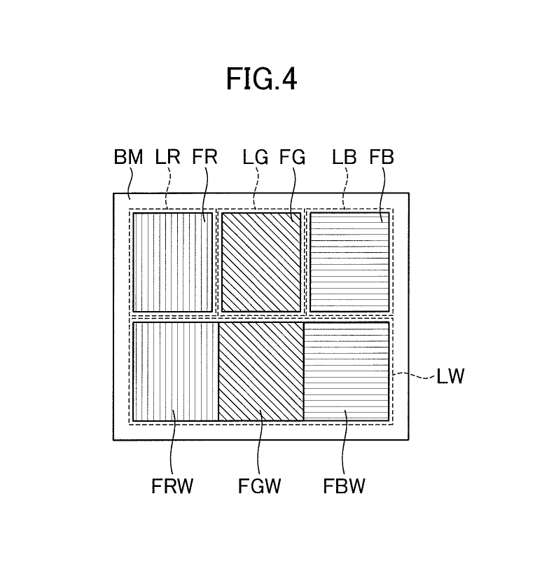

In this embodiment, the layout of the color filters and the light emission areas LW, LR, LG, LB is not limited to the above-mentioned layout. FIG. 4 is a diagram illustrating another example of a layout of the light emission areas LW, LR, LG, LB and the color filters in a certain pixel PX. Hereinafter, differences between the example of FIG. 2 and the example of FIG. 4 will be mainly described. The light emission area LW is a lower half of the area of the pixel PX. The light emission area LR, the light emission area LG, and the light emission area LB are arranged in order from the left in the upper half of the area of the pixel PX. The light emission area LW are covered with the red color filter FRW, the green color filter FGW, and the blue color filter FBW in order from the left in FIG. 4.

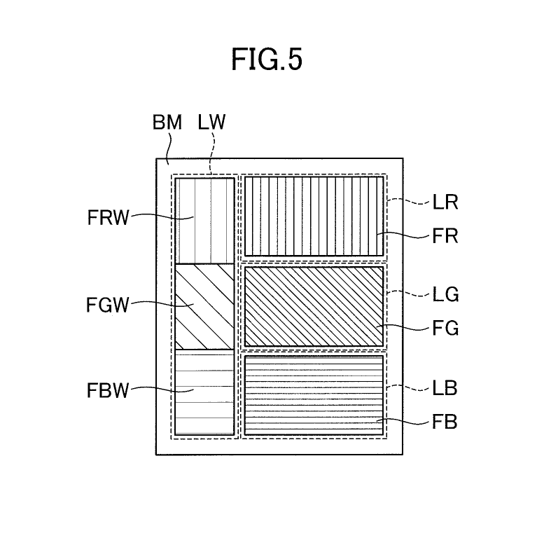

Also, unlike the examples of FIGS. 2 and 4, the transmittance of the color filters may be changed. FIG. 5 is a diagram illustrating another example of a layout of the light emission areas LW, LR, LG, LB and the color filters in a certain pixel PX. Hereinafter, differences between the example of FIG. 2 and the example of FIG. 5 will be mainly described. The light emission area LW is located on a left side of the area of the pixel PX. On a right side of the area of the pixel PX, the light emission area LR, the light emission area LG, and the light emission area LB are arranged in order from the above. In this example, the red color filter FRW is higher in transmittance than the red color filter FR. The green color filter FGW is higher in transmittance than the green color filter FG. The blue color filter FBW is higher in the transmittance than the blue color filter FB. The sizes of the light emission area LR, the light emission area LG, and the light emission area LB are identical with each other, and the size of the light emission area LW is smaller than a total of the light emission area LR, the light emission area LG, and the light emission area LB. With the above configuration, the amount of light output by the light emission area LW can be increased while balancing a change in the color tone, so that the power consumption can be further reduced.

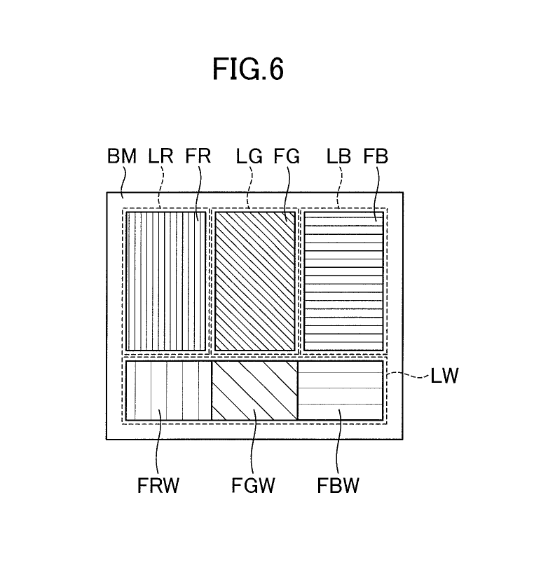

Also, in this example, the layout of the color filters and the light emission areas LW, LR, LG, LB may be further changed. FIG. 6 is a diagram illustrating another example of a layout of the light emission areas LW, LR, LG, LB, and the color filters in a certain pixel PX. Hereinafter, the differences from the example of FIG. 5 will be mainly described. In the example of FIG. 6, the light emission area LW is located on an upper side of the area of the pixel PX. The light emission area LR, the light emission area LG, and the light emission area LB are arranged in order from the left on a lower side of the area of the pixel PX. The sizes of the light emission area LR, the light emission area LG, and the light emission area LB are identical with each other, and the size of the light emission area LW is smaller than a total of the light emission area LR, the light emission area LG, and the light emission area LB.

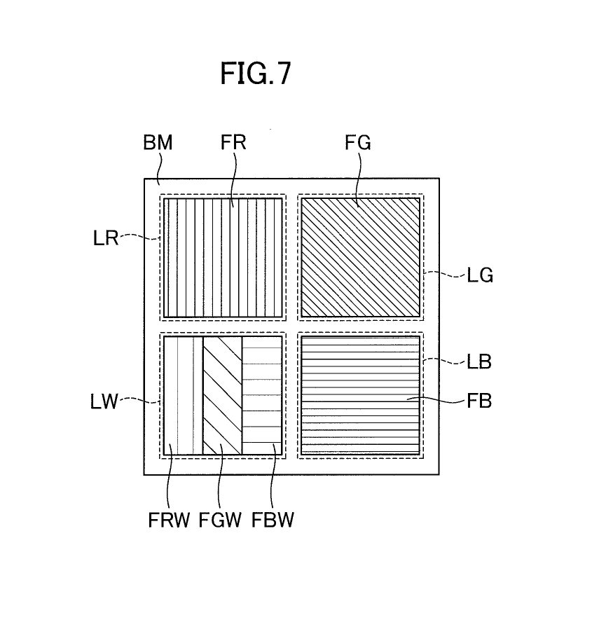

Also, FIG. 7 is a diagram illustrating another example of a layout of the light emission areas LW, LR, LG, LB and the color filters in a certain pixel PX. In this example of FIG. 7, the four rectangular light emission areas LW, LR, LG, and LB having the same area are arranged in the area of one pixel PX. The light emission area LR is located on an upper left of the area of the pixel PX, the light emission area LG is located on an upper right of the area of the pixel PX, the light emission area LB is located on a lower right of the area of the pixel PX, and the light emission area LW is located on a lower left of the area of the pixel PX. The light emission area LW is covered with the red color filter FRW, the green color filter FGW, and the blue color filter FBW in order from the left. As illustrated in FIGS. 6 and 7, even if the layout of the sub-pixels is different, the advantages of the present invention are obtained.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display device comprising:
a plurality of pixel circuits;
a red color filter that transmits a red light;
a blue color filter that transmits a blue light; and
a green color filter that transmits a green light,
wherein each of the plurality of pixel circuits includes a light emission area that outputs a white light of brightness corresponding to an input image signal, and
wherein the light emission area of the pixel circuit that receives the image signal indicative of the brightness of white among the plurality of pixel circuits is covered with the red color filter, the blue color filter, and the green color filter, respectively.

2. The display device according to claim 1,
wherein a light emission area of the pixel circuit that receives an image signal indicative of the brightness of red among the plurality of pixel circuits is covered with the red color filter,
wherein a light emission area of the pixel circuit that receives an image signal indicative of the brightness of blue among the plurality of pixel circuits is covered with the blue color filter,
wherein a light emission area of the pixel circuit that receives an image signal indicative of the brightness of green among the plurality of pixel circuits is covered with the green color filter, and
wherein the pixel circuit that receives the image signal indicative of the brightness of red, the pixel circuit that receives the image signal indicative of the brightness of blue, the pixel circuit that receives the image signal indicative of the brightness of green, and the pixel circuit that receives the image signal indicative of the brightness of white express one pixel.

3. The display device according to claim 2,
wherein the transmittances of the red color filter, the blue color filter, and the green color filter which cover the light emission area of the pixel circuit that receives the image signal indicative of the brightness of white are larger than the transmittances of the red color filter, the blue color filter, and the green color filter which cover the light emission areas of the pixel circuits that receive the image signals indicative of the brightness of red, blue, and green, respectively.
